(19) United States
(12) Patent Application Publication
(10) Pub. No.: US 2009/0254259 A1
(43) Pub. Date: Oct. 8, 2009

(54) Third Party Speed Control Device

(76) Inventor: Jacob K. The, Burnaby (CA)

Correspondence Address: Jacob The, 4600 Albert St., Burnaby, BC, V5C 2G8, CA

(21) Appl. No.: 12/418,805

(22) Filed: Apr. 6, 2009

(30) Foreign Application Priority Data
Apr. 8, 2008 (CA) CA 2629445

(51) Int. Cl. G06F 7/00; G01S 1/00

(52) U.S. Cl. 701/70; 342/357.09

(57) ABSTRACT

The present invention relates to a system and method of controlling vehicular speed, in particular by a third party, which uses data relating to geography and operator. In some instances, it is desirable to limit the power generated by an engine of a vehicle, to limit the maximum speed of the engine or to have a cruise control function on the vehicle for example. An electronic control unit ECU may be fitted to an engine, whilst a throttle valve is controlled by an operator/driver of a vehicle, this leaves the ECU operable to control the ignition and, where available, the injection, in order to control or adjust the power of the engine. For example, when the engine reaches a predetermined maximum speed, the ECU will control the engine such that some of the spark plugs are not fired and/or that fuel is not injected in every combustion chamber. The present invention seeks to provide an improved speed control device and system for a vehicle. In particular, the present invention seeks to provide an improved speed control device and system for vehicles, which can be subject to environmental and other third party limits. In accordance with a first aspect of the invention, there is provided a speed control device for a vehicle whereby a third party can impose supervisory control upon a specific vehicle and vehicle operator combination which cannot be override by the vehicle operator, the vehicle having a motor operable to provide motive power to the vehicle, a vehicle controller operable to receive speed data of the vehicle, a motor controller operable to control the output of the motor, an interface operable to receive data relating to a specific operator.

### FIELD OF THE INVENTION

The present invention relates to a system and method of controlling vehicular speed, in particular by a third party, which uses data relating to geography and operator.

### BACKGROUND OF THE INVENTION

In some instances, it is desirable to limit the power generated by an engine of a vehicle, to limit the maximum speed of the engine or to have a cruise control function on the vehicle for example. An electronic control unit ECU may be fitted to an engine, whilst a throttle valve is controlled by an operator/driver of a vehicle, this leaves the ECU operable to control the ignition and, where available, the injection, in order to control or adjust the power of the engine. For example, when the engine reaches a predetermined maximum speed, the ECU will control the engine such that some of the spark plugs are not fired and/or that fuel is not injected in every combustion chamber.

Recent developments in the field of automotive electronics now allow these vehicles to be equipped with what is known as a throttle-by-wire system. In such vehicles, a throttle operator position sensor senses the position of the throttle operator, transmits this position to the ECU, and the ECU sends a signal to a throttle valve actuator, an electric actuator for example, to adjust the degree of opening of the throttle valve based on the position of the throttle operator. This way, the degree of opening of the throttle valve is also a variable, in addition to the ignition and fuel injection, which can be adjusted by the ECU. Vehicles using such systems can therefore use the degree of opening of the throttle valve to limit the speed of the engine. When a predetermined maximum engine speed is reached or exceeded, the ECU will not cause the throttle valve to be opened further or will cause the degree of opening of the throttle valve to be reduced notwithstanding the fact that the signal from the operator position sensor communicated to the ECU indicates a desire by the driver to increase the speed of the engine.

This greatly improves the control of the engine; however controlling the engine based on the engine speed may not be ideal in some instances. For example, regulations prevent personal watercraft manufacturers from making personal watercraft that can exceed 105 km/h (65 MPH). For the same engine speed, the personal watercraft will go at a different speed depending on the load on the vehicle (i.e. weight of the driver, passengers, and items carried on board). Therefore, the predetermined maximum engine speed must be selected such that the personal watercraft will not exceed 100 km/h no matter how light the load on it is. This causes a reduced performance of the personal watercraft when the load is increased (driver with passengers for example) since it will have a lower maximum speed than when a lighter load is present (only the driver for example). Similar instances also exist for land vehicles.

Throttle-by-wire systems also simplify the implementation of cruise control systems on vehicles. In automotive applications the cruise control is typically engaged by pressing a button on the steering wheel of the vehicle and can be disengaged by pressing the button again or by pressing the brake. However, this method may not be applicable to every type of vehicle, such as personal watercraft given their lack of brakes.

EP1003651 discloses a method to control the speed of a vehicle by means of a cruise control device, essentially by arranging the cruise control device in at least one of: a cruise control state, in which the speed of the vehicle is controlled preferably with regard to a selected constant speed, a retardation state, in which the speed of the vehicle is controlled towards a determined constant speed, an acceleration state, in which the speed alternation is achieved preferably manually, an inactive state, in which the system is temporary or permanently switched off, and a distance control state, in which substantially a distance of the vehicle to a vehicle ahead is controlled. The method further comprises the step of arranging the cruise control in a temporary state, in which a speed at transition time to this state is maintained.

U.S. Pat. No. 7,315,779 discloses a vehicle having an engine, an electronic control unit (ECU), a throttle valve, a throttle valve actuator, and a throttle operator. A throttle operator position sensor senses a throttle operator position. A vehicle speed sensor senses a vehicle speed. The ECU sends a control signal to the throttle valve actuator based on the throttle operator position and the vehicle speed. The throttle valve actuator adjusts the opening of the throttle valve in response to the control signal. If the vehicle speed is lower than a predetermined maximum vehicle speed, the throttle valve actuator adjusts the opening of the throttle valve based on the throttle operator position signal. If the vehicle speed is higher than the predetermined maximum vehicle speed, the throttle valve actuator reduces the degree of opening of the throttle valve. A method of controlling an engine is also disclosed.

### OBJECT TO THE INVENTION

The present invention seeks to provide an improved speed control device and system for a vehicle.

The present invention seeks to provide a speed control device and system for a vehicle that can be controlled by third parties and/or be determined by geographical limits and the vehicle operator will not be able to override the third party controlling.

### SUMMARY OF INVENTION

In accordance with a first aspect of the invention, there is provided a speed control device for a vehicle whereby a third party can impose supervisory control upon a specific vehicle and vehicle operator combination in which the vehicle operator will not be able to override the third party controlling, the vehicle having a motor operable to provide motive power to the vehicle, a vehicle controller operable to receive speed data of the vehicle, a motor controller operable to control the output of the motor, an interface operable to receive data from an ID card and card reader relating to a specific operator;

wherein the vehicle controller is operable to compare the speed of the vehicle relative to operational limits particular to the specific operator and in the event that the speed has exceeded a first threshold, then the controller causes an alarm to be activated whereby the operator can be alerted to the fact that a first threshold has been reached whereby the operator can take corrective action.

Conveniently, in the event that despite the operation of the alarm, a second threshold is reached, then the vehicle controller causes a further alarm to be activated whereby the operator can be alerted to the fact that a second threshold has been reached.

In the event that despite the operation of the alarm, a second threshold is reached, then the vehicle controller causes a further alarm to be activated whereby the operator can be alerted to the fact that a second threshold has been reached and, in the event that the operator take no corrective action, the motor controller will take appropriate action to alter the speed of the motor, whereby to reduce the speed of the vehicle. The motor controller takes instructions from the vehicle controller and is operable to:
i) allow normal operation of the engine;
ii) prevent operation of the motor;
iii) control the operation of the motor within certain limits.

In the alternative, other methods of reducing speed are deployed.

The motor can be selected from one of an electric motor, a spark ignition internal combustion motor; a compression ignition internal combustion motor; a gas turbine motor; a steam driven motor; a compressed air motor.

The speed data of the vehicle speed can be determined with reference to a satellite-positioning signal. A secondary speed determination system can be provided, which secondary system is operable to provide speed data in addition to the primary speed data or speed data in the event of non-reception of a primary signal data. In the alternative, if GPS (Global Positioning System) is not installed in the Third Party Speed Control Device, the secondary speed sensor is automatically become the main Speed sensor unit.

The vehicle can be a road vehicle, such as an automobile, a truck, a commercial goods vehicle, a passenger service vehicle, a motorbike, an off-road vehicle, such as a four-by-four general-purpose vehicle, a motor-cross or enduro motorcycle, a watercraft or a self-propelled snow vehicle.

The interface operable to receive data relating to a specific operator can comprise one of: a card reader device operable to read optically, or magnetically encoded data stored upon a card; low-power wireless technology (such as Bluetooth™), a DVD player, operable to read data stored upon a DVD; a data entry pad, operable to receive manually input data, and: a USB connector operable to read data stored upon a USB stick or other memory device with a USB connector. There are several methods of enabling the entry of electronic data to the CCU to activate the system of Third Party Speed Control Device, such as by using a Third party speed control card with Card reader or by using Finger Print of the operator or Key Pad or Pin Number or Remote Control.

The third party can be a parent or spouse of an operator; a traffic control authority, government authority, a transport firm, or a general business. Conveniently, the vehicle operator cannot override the third party supervisory control during operation.

Conveniently, the vehicle control unit is equipped with an electronic memory operable to record data relating to previous journeys, and/or previous operators and/or navigational data relating to speed limits.

Preferably, each component of the controller device has a tamper evident seal, whereby to prevent or alternatively indicate non-authorized disconnection or adjustment of the speed control device that has been installed in the vehicle. That is to say, all electronic connections of the components or parts for transmitting or signalling electronic data and the electronic connection to the motive system are arranged with tamper-proof/tamper-evident seals or other means of protection.

In accordance with a still further aspect of the system, there is provided a speed control system for third party use including a plurality of vehicles fitted with the speed control device as described herein. It will be appreciated that this would be of benefit to many sectors of the community; goods are transported responsibly, with emissions and the like maintained or reduced relative to

Generally, the present invention provides a method and a system incorporating a third party speed control device comprising a card reader, Global Positioning System software (GPS) and hardware with speed sensor, and a secondary speed sensor of ground speed sensor or gearbox speed sensor or other means of speed sensors, are components or parts that are all in electronic communication with a programmable Computer Control Unit (CCU) with memory and hardware; a relay is associated with the CCU or electronically connected externally for accepting electronic control signal from the CCU and form a complete device operated by using electrical power or energy, and installed in any vehicle having at least one engine for the operator to start or ignite and able to move the vehicle forward or reverse with excessive speed in public places and the operator determines a direction where the vehicle is going, by way of turning the Steering Wheel of a vehicle having three or more wheels, steering gear of a ship, boat or vessel, Steering Bar of a motorbike, watercraft or snowmobile, or by remote control.

The card reader can comprise an integral part of the housing of Third party speed control device and may be formed from metal or plastics or built or can be installed separately in a suitable place inside the subject vehicle. The card reader is in electronic communication with the CCU and transmitting electronic data of a Third party speed control card entered by the operator by way of swiping, inserting, attaching, waving in front of or otherwise the Third party speed control card to the card reader as arranged, for the CCU electronically comparing and matching the newly entered electronic data from the Third party speed control card via the card reader relative to the pre-downloaded electronic data of the operator, and the CCU to electronically deactivating the relay causing electronically activation of the system that is creating power to the engine, allowing the operator to start the engine of the vehicle; further, when the CCU is comparing between electronic speed data of the vehicle obtained from the GPS speed sensor or secondary speed sensor relative to the pre-downloaded electronic data of the operator obtained from the Third party speed control card via the card reader that the speed of the vehicle has been exceeded predetermined maximum speed of the operator, the CCU is electronically transmitting warnings followed by control signal to electronically activating the relay to cause electronically pulsing the system that is creating power to the engine, means the relay is arranged for accepting electronic control signals from the CCU for multiple controlling purposes by the CCU as follows:
a) completely electronically deactivating the system that is creating power to the engine;
b) electronically activating the system that is creating power to the engine;
c) electronically pulsing the system that is creating power to the engine;
d) electronically re-stabilize the pulsed system that is creating power to the engine.

Since the operator is avoided from moving the vehicle to exceed a predetermined maximum speed data obtained by CCU from the third party speed control card via the card reader and also avoided from moving the vehicle to exceed the zoning maximum speed electronic data of GPS obtained by the CCU, the maximum speed of the vehicle is therefore under control and enforcement by electronic data entered in the third party speed control card of the operator by a third party and also under control by electronic data obtained from the GPS by CCU, means for public safety and safety of mostly young and new operators such as learner drivers and all operators prefers to operate the vehicle with excessive speed.

### BRIEF DESCRIPTION OF THE DRAWINGS

Embodiments of the invention will now be described, by way of example only, with reference to the drawings, in which:

FIG. 1 is a schematic diagram illustrating the components of a system in accordance with the present invention;

FIG. 2 is a flow chart illustrating a method of controlling vehicle speed in relation to a pre-determined speed limit according to one aspect the present invention;

FIG. 2a is a continuation of FIG. 2;

FIG. 3 is a flow chart illustrating a method of controlling vehicle speed in relation to a predetermined speed limit according to a further aspect of the invention;

FIG. 3a and FIG. 3b are continuations of FIG. 3.

### DETAILED DESCRIPTION OF THE INVENTION

In order to provide a better understanding of the present invention an embodiment of the invention will now be described. It will be apparent, however, to one skilled in the art, that the present invention may be practiced without these specific details. This should not be construed to limit the present invention, but should be viewed merely as an example of a specific way in which the invention can be implemented. Well known features have not been described in detail so as not to obscure the present invention.

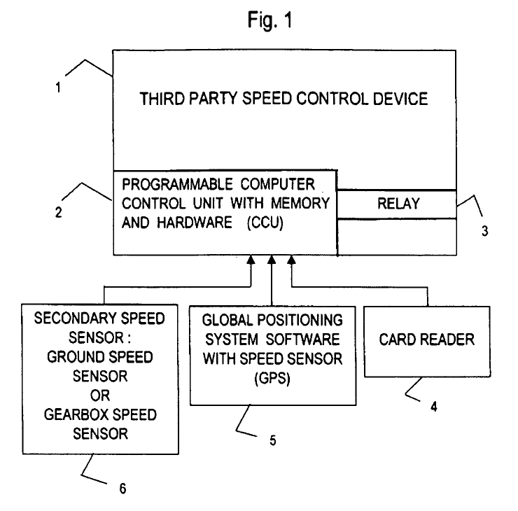

The present invention will be described with respect to a method and a system for third party speed control device capable of controlling and insisting any operator to obey a third party determining maximum speed that the operator is allowed to operate any vehicle with speed in public places whereby the operator will not be able to override the third party controlling. FIG. 1 shows, schematically the major components of a first embodiment of the invention; there is provided a third party speed control device 1 comprising a card reader 4, Global Positioning System (GPS) Software and hardware with Speed sensor (GPS) 5; a secondary speed sensor of the vehicle relative to the ground. The vehicle may comprise any powered vehicle such as a car, agricultural or commercial lorry, van, tractor etc., motorcycle, trike, boat, jet-ski or ship. The secondary speed sensor may comprise a gearbox sensor 6 or other type of speed sensor. Such speed sensors are in communication with a Programmable Computer Control Unit having a memory and associated hardware (CCU) 2. A relay 3 is shown as comprising part of the CCU 2 but can be placed separately and connected to accept electronic control signals from the CCU 2 and form a stand-alone device, being installed in any vehicle having at least one engine controllable by an operator. The engine or engines may be electric motors, internal combustion engines or otherwise, being capable of moving the vehicle in forward or reverse directions in public places where speed limits may need to be adhered to; the operator would be capable of controlling a direction of the vehicle, by use of a steering wheel, handlebar, rudder or otherwise.

The Card reader 4 can comprise an integral component of a metal or plastics housing of Third party speed control device 1 or can be made and installed separately in a suitable place inside the vehicle. The card reader is in electronic communication with the CCU 2 and transfers data from a third party speed control card (not shown) entered by the operator by way of swiping, inserting, waving or attaching the Third party speed control card (not shown) to the Card reader 4 as arranged, for the CCU 2 to compare and match the newly entered electronic data from the Third party speed control card (not shown) via the Card reader 4 relative to the pre-downloaded electronic data of the operator, and the CCU 2 to electronically deactivate the relay 3 so as to cause electronic activation of the system that is controls the output of the engine, allowing the operator to start the engine of the vehicle; In the event that CCU 2 compares speed data of the vehicle obtained from the GPS Speed sensor 5 (or Secondary speed sensor 6) relative to the pre-downloaded electronic data of the operator obtained from the Third party speed control card (not shown) via the Card reader 4 and relative to zoning maximum speed electronic data obtained from GPS 5, that the speed of the vehicle has exceeded a maximum speed of the operator/geographical speed limit, then the CCU 2 will transmit warnings followed by operation of the relay 3 whereby to transmit control signals to the motor, engine or engine components, to control the motor or engine. The control system could control by transmitting pulsed signals. In a limit condition, the motor or engine could be completely be de-activated.

Programming to the electronic Memory of the CCU 2 is divided in the following three partitions:

a) permanently record electronic data initially transmitted or downloaded from Third party speed control card (not shown) of each operator by using a dual-functions of electronic Portable Machine (not shown), to identify each operator that is operating the same vehicle and for fundamental, of deactivating the relay 3 to cause system that is creating power to the engine of the vehicle functional when any electronic data transmitted from a Third party speed control card (not shown) via the Card reader 4 matches with any of the pre-downloaded electronic data of the operators, and controlling the maximum speed of each operator determined by third party; the dual-functions of Electronic Portable Machine (not shown) is also arranged for correcting any wrong or out-dated electronic data entered previously and identification or serial number of each dual-functions electronic Portable Machine is also recorded during each process;

b) permanently record electronic data from newly entered Third party speed control card (not shown) of the operator which is electronically transmitted via the Card reader 4, to identify as the last operator of the vehicle in case accident is involved and no one comes forward, and the electronic data is kept in this memory storage until the memory storage has been used up, than “first entered first go” rule is applied for always keeping electronic data of the last performance as proof of record and extra space is arranged to upgrade or addition of the electronic Memory chip for larger capacity; simultaneously, predetermined electronic speed data of the last operator is transmitted to electronic Memory c);

c) temporary holding electronic data transmitted from b) for comparing the pre-downloaded electronic speed data of the operator in a) relative to zoning maximum electronic speed data obtained from GPS 5 and relative to electronic speed data transmitted from the GPS Speed sensor 5 or from the Secondary speed sensor 6, and electronically controlling the system that is creating power to the engine via the relay 3 and also controlling the warnings; all electronic data in this particular memory storage is deleted every time the operator is turning the electrical power “off”.

d) The CCU is also programmed to have a “Learn Mode”, using GPS speed sensor to calibrate the secondary speed sensor systems.

Upon the completion of an installation of the third party speed control device to a vehicle, the installer will drive the vehicle and let say the CCU obtained speed information from the GPS speed sensor is 180 km/hr and obtaining pulse count from the secondary speed sensor is 180,000 pulses per hour; 50 pulses per second is 180 km/hr and when obtaining one pulse from the secondary speed sensor, the vehicle track 1 meter and the CCU is programmed to record these calibration data.

Data of all operators who will be operating the same vehicle can be pre-downloaded in the CCU 2 from every Third party speed control card (not shown) of each operator and this process is arranged by using a dual-functions of electronic Portable Machine (not shown); any operator swiping a Third party speed control card (not shown) to the Card reader 4 causing the Card reader 4 transmits any electronic data matches the pre-downloaded electronic data in the CCU 2, the CCU 2 will electronically deactivating the relay 3 causing electronically activation of the system that is creating power to the engine of the vehicle means the operator is now able to start the engine and move the vehicle.

By entering non-matching data or a Third party speed control card (not shown) without data or a non-authorized card to the Card reader 4, CCU 2 will not electronically deactivating the relay 3 and therefore, activation of the system that is creating power to the engine will not happen and the engine will not start, means adding protection to the vehicle being operated by non-authorized person.

To prevent unexpected to happen during emergency, CCU 2 is also programmable to allow operation of vehicle without the operation of third party speed control card (not shown) and card reader 4 but having limited and nominal vehicle maximum speed, for example at 50 km per hour, and this limited maximum speed is adjustable according to consideration of the third party who is controlling the operator, until the data in the third party speed control card (not shown) is entered to the card reader 4, than the controlling maximum speed is adjusted accordingly.

The nominal vehicle speed will also be active when CCU 2 looses zone maximum speed signal during high speed operation of the vehicle, for example at the exit of a highway. For safety of the vehicle operator and the operator of a vehicle following behind, CCU 2 is connected to the vehicle system of blinking rear emergency lights having adjustable delay mechanism controlling the engine when CCU 2 losses maximum speed signal from GPS with adjustable timer after the blinking rear lights activation relative to adjustment of the engine.

Third Party such as Parents, husband/wife, traffic control authority, Government authority, Insurance company and other controlling authority is able to take control of determining and insisting allowable maximum speed of the operator by way of entering the predetermined maximum speed and personal identification data of each operator to a computer, than electronically transmitting and storing the entered data to a Third party speed control card (not shown) by using a dual-functions of electronic Portable Machine (not shown) connected to the computer; the third party controlling and determining maximum speed that is allowed for each operator to operate any vehicle in public places can be arranged differently according to past performance or behaviour of each operator.

A Third party speed control card (not shown) is issued to each operator for keeping personal identification electronic data and predetermined maximum speed electronic data of each operator, and duplication of the card is possible.

Conveniently the system operates with reference to GPS data, which is passed to CCU 2, whereby CCU 2 can electronically control the speed of the vehicle according to the zoning maximum speed electronic data obtained from the GPS 5; electronic data transmitted to CCU 2 from Third party speed control card (not shown) via the Card reader 4 and from the GPS 5 determine various maximum speeds of the vehicle that an operator is allowed to perform in public places, such that the operator has no control over the electronic data of predetermined maximum speed electronically entered to the Third party speed control card (not shown) and also no control over the electronic data of zoning maximum speed of the GPS 5 transmitted to the CCU 2, simultaneously the electronic memory of CCU 2 is arranged to keep electronic record of identification when the operator swiped the Third party speed control card to the Card reader 4 and the Card reader 4 transmits the electronic data to the CCU 2.

The electronic memory of CCU 2 can be increased to retain electronic records of previous performances; each operator may use only the method and system for Third party speed control device 1 or with combination of zoning maximum speeds of GPS 5.

In the event of failure of the GPS 5 device, for determining the speed of the vehicle, the CCU 2 is arranged for automatically detect such an occurrence and switch to a secondary speed sensor 6 which can determine the speed of the vehicle and transmitting speed data to the CCU 2 for the CCU 2 continue controlling the engine management system so as not to allow the vehicle to exceed any predetermined maximum speed according to pre-determined operator data or other geographical data. This would enable the vehicle to operate in the event that, for example, a GPS antenna is shielded from receiving GPS signals, whether intentionally or not; an operator may surround the antenna with a metallic shield; the vehicle may travel through a tunnel, in which case GPS signals would not be received by the vehicle's system. In such an event, the above-stated situations would not affect the Third party speed control device 1 for constantly electronically controlling the speed limitation of the vehicle according to electronic data obtained from the third party speed control card (not shown) via the Card reader 4; CCU 2 is also electronically connected to the vehicle Canbus System to take over map reading from the GPS without reception of satellite signal while transferring the map data to CCU 2 for continue controlling purpose.

Upon return to normal GPS data reception, the system would revert to normal speed sensing control, automatically transferring reception of speed data from the secondary speed sensor 6 to reception of data from the GPS Speed sensor 5, and CCU 2 will automatically adjust operation at the same time. As will be appreciated, if the secondary speed control device is driven from, for example, a propeller shaft, then a suitable electromechanical speed device would be required. Evidently, in the event that a vehicle does not have a GPS device, then such a speedometer would be the primary indicator of vehicle speed.

The relay 3 that is connected to the CCU 2 is accepting electronic control signals from the CCU 2, the relay 3 is further in electronic connection with the system that is creating power to the engine; at time the vehicle reaches predetermined maximum speed according to electronic data obtained by the CCU 2 from third party speed control card (not shown) via the card reader 4 or the vehicle reaches electronic data of the zoning maximum speed obtained by CCU 2 from the GPS 5, whichever is lower, first warning of blinking light is arranged for the operator which is also for operators with bad hearing ability, to give an opportunity to the operator to react and not to proceed with any exciting movement of the vehicle that possibly endanger public in the surrounding area, and the operator, and any passenger carried on board;

upon failure or negligence of the operator to reduce speed or maintain the vehicle at the maximum allowable speed at the first warning, a second warning in different colour of blinking light with sound are arranged at time the vehicle has exceeded a little over the predetermined maximum speed electronic data of Third party speed control card (not shown) or exceeded a little over the zoning maximum speed according to the GPS 5, just prior the CCU 2 to electronically activating the relay 3 to cause electronically pulsing the system that is creating power to the engine, that could be the system of computerize Engine Control Management or Fuel Injection system or Fuel Pump system or Ignition Coil system or Distributor system; and again, upon failure or negligence of the operator to reduce or maintain speed of the vehicle as at the second warning, in response of the CCU by comparing between: the predetermined electronic speed data of the operator obtained from Third party speed control card (not shown) via the Card reader 4 and zoning maximum speed electronic data obtained from the GPS relative to electronic speed data of the vehicle obtained from GPS Speed sensor 5 or Secondary speed sensor 6, the CCU 2 is electronically activating the relay 3 causing electronically pulsing the system that is creating power to the engine at time the vehicle has exceeded a little over the speed as at the second warning; the arrangement of electronically pulsing the system that is creating power to the engine is not to totally stopping the engine or put the engine back to idle at once during fast speed movement of the vehicle which is preventing from a sudden total engine stalls if deactivation of the system that is creating power to the engine occurred during fast speed movement of the vehicle that possibly endanger the operator and any passenger carried on board and any other surrounding public place users and anything nearby, means insisting the vehicle safely not to move any faster and therefore, the vehicle is decelerating (except, for example a vehicle is travelling down hill) means insisting the operator for obeying the electronic data entered in the third party speed control card (not shown) and or obeying zoning maximum speed electronic data of GPS 5 transmitted to the CCU 2, preventing from any excessive speed accident, harm or danger to the operator and to any passenger carried on board and to any other surrounding public place users and anything nearby.

Since the operator is avoided from moving the vehicle to exceed the predetermined maximum speed data obtained by CCU 2 from the third party speed control card (not shown) via the card reader 4 and also avoided from moving the vehicle to exceed the zoning maximum speed electronic data of GPS 5 obtained by the CCU 2, the maximum speed of the vehicle is therefore under control and enforcement by electronic data entered in the Third party speed control card (not shown) of the operator by a third party, and also under control by electronic data obtained from the GPS 5 by CCU 2, whereby the operator is not able to override the third party controlling means for public safety and safety of mostly young and new operators such as learner drivers and all operators prefers to operate the vehicle with excessive speed.

As a result of electronic data comparison by the CCU 2 between: predetermined maximum speed electronic data of the operator obtained from the Third party speed control card (not shown) via card reader 4 and zoning maximum speed electronic data obtained from the GPS 5 relative to speed electronic data of the vehicle obtained from GPS speed sensor 5 or secondary speed sensor 6, the operator will than be able to continue to operate the vehicle with a speed dependent upon the GPS speed sensor 5 or the Secondary speed sensor 6 is in electronic communication indicating or signalling or electronically transmitting speed data of the vehicle to the CCU 2 that speed of the vehicle has been decreased to or below speed as at the second warning, causing the CCU 2 electronically deactivating the electronically activated relay 3 to cause electronically reactivating and re-stabilize the pulsed system that is creating power to the engine, means adjustment for more power to the engine is now possible. The relay can conveniently be set up so as to either set the relay “on” to trigger signal from CCU, or to set the relay “off” to trigger signal from CCU.

Slow or fast speed movement of the vehicle is determined by the operating performance of the engine which is controlled by the operator by way of adjusting directly or indirectly of the, gas pedal, drive-by wire, electrical wire, coil wire, ignition wire, ignition coil, fuel injector, fuel pump, knob, lever, distributor, remote control, or other means of mechanism or system that is regulating the engine power to cause the engine to move the vehicle via other mechanisms and or other parts, directly or indirectly, at least with one wheel, propeller, chain, skate, belt, hot air, jet, or other means that is allowing the vehicle to move easily and smoothly to catch speed.

To prevent from non-authorized disconnection or adjustment to the third party speed control device 1 that has been installed in the vehicle, all electronic connections of the components or parts for transmitting or signalling electronic data and the electronic connection to the system that is creating power to the engine are arranged with proper seals or other means of protections. There are several methods of arrangement for entering matching electronic data to the CCU 2 to activate the system of third party speed control device, such as by using a Third party speed control card (not shown) with Card reader 4 as illustrated above or by using Finger Print of the operator or key pad or pin number or remote control.

The CCU 2 is arranged to keep electronic record of identification of the operator after swiping the third party speed control card (not shown) to the card reader 4 whereby to transfer data to CCU 2, means benefiting the authority for electronic record tracking with full third party controlling as how far back the recording is required, by simply inserting electronic memory chips can be associated with the CCU 2 with sufficient electronic memory capacity appropriate for the duty; conveniently, the memory chips can comprise USB memory sticks; these can provide 2-8 GB memory at low cost; larger memory units of 50 GB+ can also be connected via USB leads which are inserted into the USB ports of the CCU. Other forms of string data can also be utilized.

The third party speed control device 1 is a stand-alone device that can be used in combination with other speed controlling mechanism, and can be installed during manufacture of the vehicle or installed subsequently whereby to provide to enable use of the controller to be mandated by a particular authority for requiring (enforcing) any operator to obey the predetermined speed limitation according to geographical and/or weather conditions or during particular time periods. By use of particular transmissions of electronic data and programs entered in a third party speed control card and to zoning controls relating to maximum speed can be enforced, preventing or reducing the likelihood of speed related accidents, and to seek to reduce harm or danger to the operator/passenger/goods carried on board and to any other surrounding public place users.

For third parties such as a public authority to have maximum control and enforcement to every operator to obey the predetermined maximum speed according to electronic data transmitted to the third party speed control card and according to electronic data of the zoning maximum speed of GPS 5 transmitted to the CCU 2, the use of dual-function equipment (not shown) for transmitting electronic data of each operator from a computer to a Third Party Speed Control Card, and to transmit or pre-download electronic data from a Third party speed control card to the CCU 2 permanently, are strictly distributed/provided, upon payment of a rental fee or otherwise to authorized agents in each territory of each country and also to have maximum responsibility and liability from each and every authorized agent from entering or transmitting incorrect data (by accident or maliciously) every dual-function electronic Portable Machine has a unique identity whereby use can be blocked or disabled if circumstance require. The recorder of updates etc. that are performed for particular machines can be traced and monitored using such identification or serial number and recorded during each process of transmitting electronic data from a computer to a Third party speed control card and each process of transmitting electronic data from Third party speed control card (not shown) to the CCU 2 permanently, and also during each process of making amendment to the electronic data recorded previously.

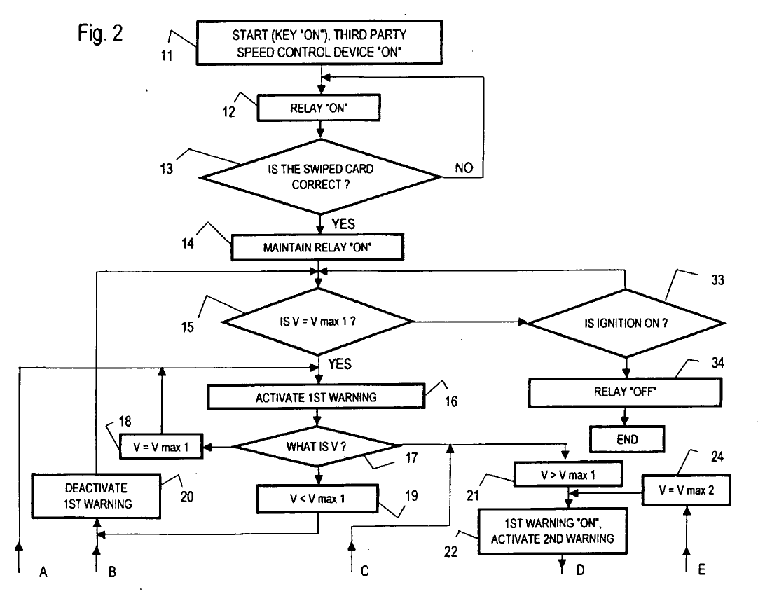

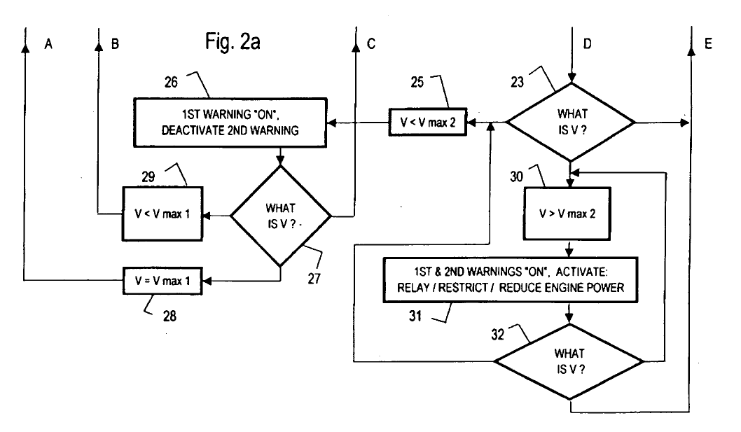

With reference to FIG. 2, a first embodiment of the invention shall be discussed, the figure being a logic illustration of a method for the third party speed control device 1, installed in a vehicle that could potentially be operated with excessive speed in public places.

Steps 11 and 12 refer to a starting procedure for the vehicle, be it a boat, lorry, taxi or otherwise; the system is turned on and the third party speed control device is activated, with a simultaneous activation of a relay 3 (step 12) to ensure that the motor or engine will not operate if certain criteria are not met.

In step 13, the operator is required to enter data from a third party control card which is swiped in the card reader; the card reader will read the data and it will be confirmed by CCU 2 that the data entered is correct or not; a misreading of the data may also occur and the system can request that the data be re-entered. It will be appreciated that the entering of the data is like operation of a key; other means of entering the data may be realized; for example, data transfer may be provided by an exchange of data with respect to a USB stick, a wireless transfer of data, a smart card or similar. For simplicity, continued reference to the key shall be by way of swipe card only, but the skilled artisan will realize that the system is not limited thereto.

To enable simple authorization, the card—which may be associated with a single individual operator—can be tallied with a list of all individual operators who will be operating the same vehicle that have been pre-downloaded to the CCU 2. This process can be enabled by use of a dual-function electronic portable machine; the data in the CCU 2 can conveniently comprise data relate to each operator including predetermined maximum speed electronic data as fundamental information relevant to the activation of first and second warnings, electronically deactivating the relay 3 for multiple controlling purposes by the CCU 2, and controlling the maximum speed of each operator determined by a third party, specific duties for a particular journey etc.

In the event that non-matching data or a non-authorized third party speed control card is presented to card reader 4, the CCU 2 will not electronically deactivate the relay 3 and therefore, electronic activation of the system controlling the engine will not happen and the engine will not start and the cycle brings the operator back to step 12, the system thereby prevents use of the vehicle by a non-authorized person.

In step 14, any operator swiping a valid third party speed control card through the card reader 4 will cause the card reader 4 to transmit any electronic data to CCU 2, any transmitted electronic data that matches the pre-downloaded electronic data in the CCU 2 will cause CCU 2 to deactivate the relay 3 enabling the engine control system of the vehicle whereby the operator is enabled to start the engine and to move the vehicle.

The requirements for starting the engine in step 15 need then to be satisfied, which, in the affirmative will enable the engine to be started. During operation of the vehicle, the CCU 2 will constantly compare actual speed determined from electronic speed data of the vehicle determined from speed sensor 6 and the predetermined maximum speed electronic data of the operator obtained in step 13; the operator will further have the options as detailed with reference to steps 16 and 33, below.

In step 16, during sensing of the speed-by-speed sensor 6, the sensor 6 will constantly transmit speed data to CCU 2 for the CCU 2 to compare with predetermined maximum speed electronic data of the operator as previously obtained at step 13. Upon the vehicle reaching the predetermined maximum speed, CCU 2 will transmit a first warning signal e.g. a blinking light or an audible warning for the operator whereby to enable the operator to check his speed, to give an opportunity for the operator to react and not to proceed with any excessive speed of the vehicle that possibly endangers others.

Whilst the first warning is operational, as disclosed in step 17, CCU 2 constantly compares the measured speed, as determined from the speed sensor relative to the predetermined maximum speed as known from step 13. Alternative steps 18, 19 and 21 are taken, dependent upon actions taken.

In step 18, whilst the first warning is operational, through failure of the operator to realize or intentional disregard of the first warning, whilst maintaining the speed as at the first warning, then the CCU 2 will maintain operation of the warning indicators per steps 16, 17, and 18.

In the event that speed, notwithstanding the alarm, is increased, then a second warning system is initiated when the speed exceeds a first maximum speed, per step 21, which warning could comprise an increase in rate of flashing of the indicator light or an increase in sound of a warning buzzer or the activation of a still further warning mechanism, per step 22. The second warning may comprise an increase in the pulsing of the warning light, the light changing to a different colour.

The second warning is maintained whilst the speed is maintained at a speed equivalent to the second maximum per steps 22-23-24, until speed is reduced per steps 22-23-25-26, when the first alarm threshold is still maintained, unless the speed is reduced to a level below the first threshold, per step 27-29-20, when the first warning is deactivated. If, on the other hand, the speed is still maintained at the level of the first threshold, then the first warning alarm remains active, per steps 29-28.

In the event that the speed of the vehicle, in view of the alarm, is reduced, then the speed becomes less that the first threshold speed and the first warning alarm is deactivated, per steps 19-20, when CCU 2 has determined from the speed sensor data that the vehicle speed is below the threshold of the predetermined maximum speed electronic data of the operator obtained in step 13, that the vehicle has been reduced to below the speed as at the first warning which is the predetermined maximum speed of the operator, and the operator is able to keep the vehicle moving and the cycle brings the operator back to continue from step 15.

Continuing from steps 21, 22 and 23, in the event that speed is not decreased and is above the second threshold limit, then per step 30, the first and second warning signals would continue to operate and the engine control systems will reduce power, for example by preventing one or more cylinders in an internal combustion engine from receiving fuel, by reducing stator excitation in a electric motor per step 31. Indeed, the CCU 2 may electronically activate the relay 3 to cause electronic pulsing of the control system for the engine, that could be the system of computerize engine control management or fuel injection system or fuel pump system or ignition coil system or distributor system. That is to say, the CCU 2 controls the relay 3 at step 31, through electronic pulsing the system or otherwise, causes the vehicle to decelerate and safely not to move any faster; In the event that speed is reduced to below the second threshold, then the second warning is deactivated, per steps 23-25-26; in the event the speed is reduced to that of the second threshold, then the second warning system remains operational, per steps 32-24-22-23-30-31. By maintaining the speed above the second threshold, then the reduction of power is maintained or even increased over time by virtue of the CCU 2 increasing its effect on the motor or engine.

During step 23, i.e. when both the first and second warnings are operational, CCU 2 is constantly electronically comparing between a predetermined maximum speed peer operator data, as obtained in step 13 and electronic speed data of the vehicle obtained from speed sensor 6 and giving the operator options of steps 24, 25 and 30.

In Step 24, during the first and second warnings, upon failure or negligence of the operator to reduce speed but maintaining the vehicle at the same speed as at the second warning, the CCU 2 maintains the second warning and continues the first warning if appropriate.

Steps 25 and 26, during the first and second warning since step 22, until the CCU 2 obtained speed electronic data of the vehicle transmitted from speed sensor 6, in result of comparison by CCU 2 relative to predetermined maximum electronic speed data of the operator obtained at step 13, that the vehicle has been reduced to below speed as at the second warning, CCU 2 is electronically deactivating the second warning at step 26, and the operator is able to keep the vehicle moving while the first warning is still in active.

Step 27, while the operator is moving the vehicle with first warning still in active, CCU 2 is constantly electronically comparing between: predetermined maximum speed electronic data of the operator obtained in step 13 relative to electronic speed data of the vehicle obtained from Speed sensor 6, upon failure or negligence of the operator to reduce or maintain speed of the vehicle as at the first warning, than the cycle brings the operator back to continue from step 21.

With reference to step 29, CCU 2 refers to vehicle speed data from speed sensor 6, and compares the same with operator permitted speed per step 13, in the event that the speed is reduced, then the first warning system is deactivated, per step 20 and the operator is able to keep the vehicle moving and the cycle brings the operator back to step 15.

Referring now to steps 30 and 31, during a period where the first warning is followed by a second warning per step 22, upon failure or negligence of the operator to reduce or maintain speed of the vehicle below the first operator defined limit as at the second warning and the operator keeps trying to increase power of the engine to increase speed of the vehicle, then CCU 2 will compare the predetermined maximum speed electronic data of the operator obtained in step 13 relative to vehicle speed data obtained from speed sensor 6, and the CCU 2 will activate the relay 3 at step 31, causing the engine to reduce power whereby the vehicle can decelerate safely and not increase or maintain speed; the arrangement of reducing the power produced by the engine to a limited extent and not bringing the engine to an idle or even completely stopping the engine enabling a safe reduction in speed of the vehicle that could otherwise possibly endanger the operator, any passenger carried on board and any third parties. In the event that the vehicle is travelling downhill, a gradient sensor may operate to apply braking means to the vehicle or otherwise reduce power to a greater extent. As a result, the system can improve the behaviour of operators and will reduce the likelihood of the vehicle having accidents by virtues of the vehicle travelling at excessive speed and reducing the likelihood of any harm or danger happening to the operator, any passenger carried on board and any third party.

In step 32, following the application of relay 3 routine by CCU 2, the speed is monitored again with reference to the predetermined operator maximum speed data obtained in step 13 and vehicle speed obtained from speed sensor 6; giving the operator the following options.
a) upon reducing the speed so that the requirements of step 25 are met and the second warning is deactivated per step 26;
b) in the event that speed is not reduce, through failure or negligence of the operator, then steps 24 and 22 are processed; the first and second warnings are maintained;
c) upon failure or negligence of the operator to reduce or maintain speed at the second warning, then the relay 3 system is brought into effect per step 31, whereby speed is reduced; and is checked in step 32; failure to reduce the speed means that the procedure 30-31-32 is maintained until speed is reduced whereby speed is equal to the second threshold per step 24 and the steps 22-23 are repeated or the speed is below the second operator threshold per step 25 whereby the second warning is deactivated in step 26.

Step 33, when the operator keeps ignition of the engine “on”, and keeping speed of the vehicle below the predetermined maximum speed according to predetermined maximum speed electronic data obtained by CCU 2 at step 13, the operator is able to keep the vehicle going smoothly as step 15.

All of the above-illustrated process will continue on the same cycle during operation of the vehicle by the operator until movement of the vehicle is stopped and the operator switches off the engine; step 34, relates to the procedure taken at the end of a journey or at a break, where the operator switches the engine off or is otherwise immobilized; the engine will not operate until the starting procedure per steps 11-12-13-14 have taken place.

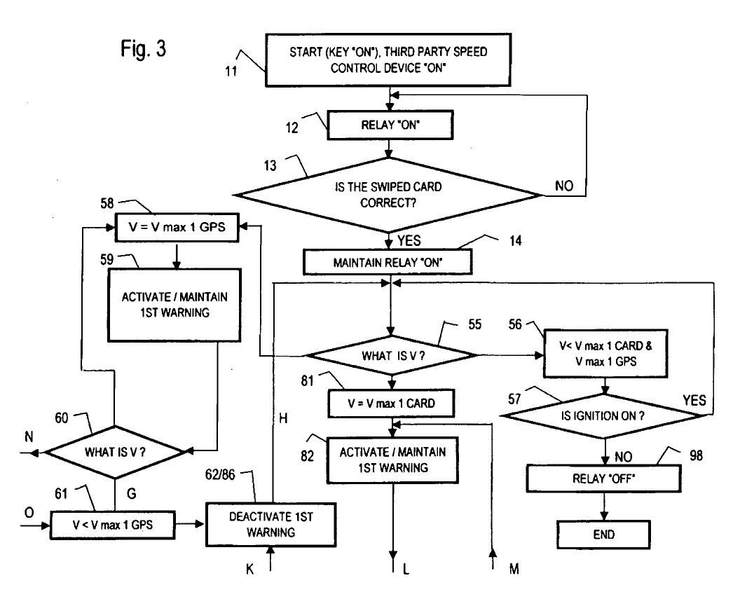

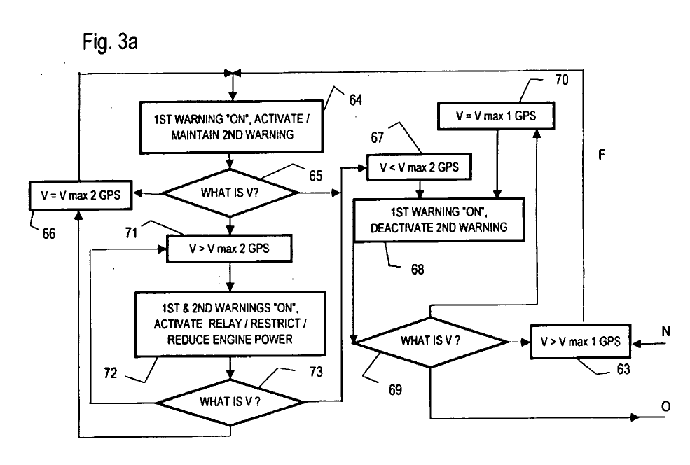

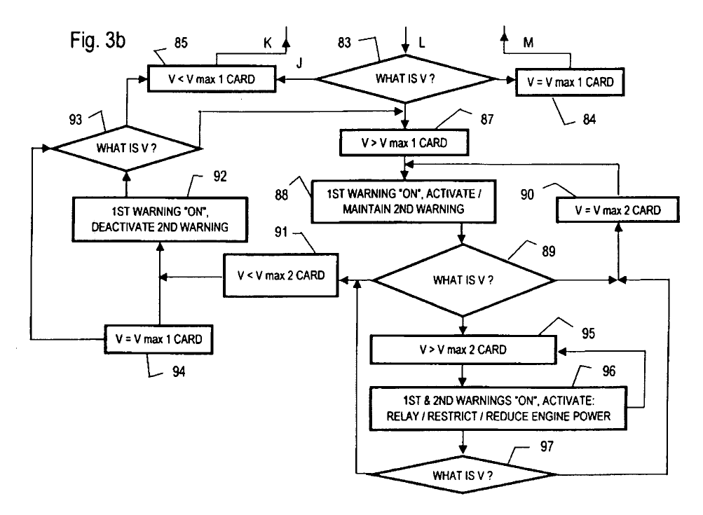

Referring now to FIG. 3, there is shown an alternative implementation of the present invention. With reference to the control lines referenced F, G, H the logic diagram illustrates a method of using GPS speed data together with use of operator defined restrictions as defined by an operator card. That is to say the identification card of the operator is utilized together with various GPS zoning speed limitations to maintain speed of a vehicle below a predetermined limit.

Referring now to steps 11-14 of FIG. 3, it can be seen that these steps correspond with the procedures of the similarly numbered steps in FIG. 2. Once the relay 3 has been deactivated, with reference to step 55, following starting of the engine and whilst the operator is in control of and operating the vehicle, the CCU 2 constantly compares data signals from the speed sensor obtained via the GPS system of the vehicle, with reference to a predetermined maximum speed relative to the operator and other input conditions, if any. Various zoning maximum speed data obtained from the GPS system 5, and electronic speed data of the vehicle obtained from GPS speed sensor 5 or secondary speed sensor 6, provide the operator with the options of steps 56, 58, 81.

When the operator of the vehicle is moving the vehicle below the predetermined maximum operator speed, as defined by the operator card, and below the geographical zone speed limit as determined for the GPS system, then no further control need be applied, nor need any warnings be issued. In step 57 assessment of the speed of the vehicle is maintained and enables the motor or engine to operate without further control and the GPS Speed sensor 5 or the secondary speed sensor constantly monitor the speed of the vehicle and pass the vehicle speed data to CCU 2 which controls power of the engine whereby the predetermined maximum speed of the operator per step 13, and the geographical maximum speed is obtained from GPS device 5. The operator is able to operate the vehicle smoothly while maintaining speed per step 56 and the cycle brings the operator back to continue from step 55.

In contrast, when the speed is increased to a speed equal to a first limit, per a geographical limit, as in the case of step 58, then a first warning system is activated; in the event that the speed is maintained, then the first warning is maintained per steps 58-59-60.

In step 60, if the speed is nonetheless increased, then step 63 test point is checked, namely “Is the speed greater than the first geographical speed threshold?”. If this is the case, then step 64 checks whether or not the second geographical threshold has been reached, in which case the second warning is activated. The test for speed is again checked per step 65 in a repeat loop, until the speed is reduced sufficiently.

In the event the speed is less than the second geographical threshold, per step 67, then the first warning is maintained yet the second warning is deactivated; the first warning is maintained if the speed is equal to the first threshold, per steps 67-68-69. In step 69, the speed is again checked, provided the loop and the speed conditions are satisfied: if the speed is less than the first geographical threshold as determined in step 61, then the first warning is deactivated per step 62 and the basic speed test of step 55 is performed. If the speed is equal to the first geographical threshold per step 70, then the first warning is maintained and the second warning is non-operational per step 68; in the event that the speed is still greater than the first geographical speed limit, per step 63, then, in step 64, the first warning is maintained and, if the second geographical limit has been reached, then the second warning-becomes operational. The speed is then again assessed at step 65: if the speed has increased then steps 63-64-65 are repeated; if the speed has reduced below first and second the geographical thresholds, then steps 67-68-69-61-62 are taken and the first warning is deactivated; if the speed is maintained then steps 67-68-69-63-64 are repeated until a change in speed is determined.

In the event the speed is the same as the second threshold speed, then steps 65-66-64 are repeated until there is a change in speed.

In the event that the speed is greater than the second speed threshold, then steps 71-72-73 are taken, namely it is confirmed that the speed is greater than the second threshold (step 71); the first and second warnings are maintained and the relay 3 is activated whereby to reduce the speed; in the event that the speed is reduced so that it is less than the second threshold, then the second warning is deactivated per steps 67-68 and the first warning light may also be deactivated if the speed is reduced per steps 69-61-62; if equal to the second threshold per step 66, then the second threshold warning is maintained and steps 64-65 are repeated.

Referring now to step 81, which relates to speed control with reference operator limits defined by data transferred from the swiped card, as determined in step 13, this step is conducted when the speed has reached the first operator defined threshold per step 81. This causes the first warning to be activated per step 82; the speed is again checked in step 83, which check is repeated in a loop fashion if the speed condition is satisfied.

In the event the speed is reduced as determined in step 85, then the first warning is deactivated per step 86, (route J/H), the test returns to step 55. In the event that the speed is maintained at the first operator defined threshold, then the first warning is maintained per step 82-83-84, until a decrease in speed is determined. In the event that the speed, nonetheless, has increased, a check is made to determine whether the speed has reached the second operator defined limit per test 87; second warning will be activated in the event that the speed is equal to or greater than the second threshold.

In step 89, the speed of the vehicle is determined: In the event that the speed is less than the second threshold, per step 91, then the second warning system becomes non-operational step 92; the speed is again re-assessed in step 93; if the speed is less than the first operator threshold, then the first warning is deactivated per step 86 and the assessment process is restarted at step 55. If the vehicle speed is equal to the first operator threshold, then, the first warning remains on per steps 94-92; if the vehicle speed has, once again increased, then the tests per step 87-88-89 are performed, once again.

In the event that the speed remains at the second operator threshold, then, per steps 89-90-88-89, the first and second warnings are maintained. In the event that the speed, nonetheless is increased, such that it exceeds the maximum operator threshold, then not only are the first and second warnings maintained, but the relay 3 is activated, whereby to reduce the speed despite any contrary efforts of the operator; the speed is again reassessed in step 97, which speed assessment loop will continue to assess the speed until the speed is decreased below the second threshold. If it remains above the second threshold, a cycle determined by steps 95-96-97 are applied, continually reducing engine power until the speed equals that of the threshold, when a cycle per steps 90-88-89 is effected; once the speed is below the second threshold, then the relay 3 no longer is applied and, via steps 91-92 the second warning is deactivated; upon further speed reduction, the first warning is deactivated and the step 55 test will be applied.

Typically the geographical speed limits will be lower than those applied for an operator. The first and second warning systems or devices could comprise any one of a number of solutions; flashing or continuously operating lights, being light emitting diodes or incandescent; buzzers, vehicle instrumentation devices or other devices that can alert an operator that speed is excessive relative to certain predetermined conditions whether they be statutory, local, operator determined or some other reason. Importantly, these limits are put into place because for safety and other factors, especially, in the case of passenger vehicles, for the safety of the passengers and other vehicles in the surrounding area or any passenger carried on board and also the operator and anything nearby.

In operation of the engine or motor control, there are many ways of achieving a reduction in power output, concomitant with a reduction in speed of the vehicle. In a multi-cylinder internal combustion engine, fuel could be prevented from being injected into one or more cylinders; spark plug timing could be advanced or retarded; equally the brakes could be applied; these are methods of reducing power output of an engine that are known; other methods could also be applied, the exact method of controlling the output from an engine not limiting the application of this invention.

In operation, the CCU 2 will constantly obtain speed electronic data of the vehicle transmitted from GPS speed sensor 5 or secondary speed sensor 6 and in result of comparison by the CCU 2 with predetermined maximum electronic speed data of the operator and any geographical zoning limits as determined by the GPS system, the vehicle can be assured of being operated within limits as can reasonably and safely be imposed upon operators. Of course, this can prevent not only poor driving by operators but can also be of advantage should the vehicle be hijacked—the invention is not only applicable to public service vehicles such as busses and coaches, but also to passenger cars and commercial goods vehicles.

In use the operator keeps ignition of the engine “on”, in an operational state, maintaining speed of the vehicle below predetermined maximum speed according to electronic speed data obtained by CCU 2 at step 13 and according to zoning maximum speed electronic data obtained from GPS, the operator is able to keep the vehicle going smoothly accelerating to exceed speed limits is futile; fuel need not be wasted; all of the above-illustrated process will continue on the same cycle during operation of the vehicle by the operator until movement of the vehicle is stopped-and the operator arranged the ignition of the engine “off”, than the electronic activation of relay 3 occurred to cause electronically deactivation of the system that is creating power to the engine means the engine will not start until the next operator start over from step 11.

1) A speed control device or system for a vehicle whereby a third party can impose supervisory control upon a specific vehicle and vehicle operator combination, the vehicle having a motor operable to provide motive power to the vehicle, a vehicle controller operable to receive speed data of the vehicle, a motor controller operable to control the output of the motor, an interface operable to receive data from an ID card and card reader relating to a specific operator;
wherein the vehicle controller is operable to compare the speed of the vehicle relative to operational limits particular to the specific operator and in the event that the speed has exceeded a first threshold, then the controller causes an alarm to be activated whereby the operator can be alerted to the fact that a first threshold has been reached whereby the operator can take corrective action.

2) A speed control device as claimed in claim 1, wherein the third party supervisory controlling cannot be override by the vehicle operator.

3) A speed control device as claimed in claim 1, wherein, in the event that despite the operation of the alarm, a second threshold is reached, then the vehicle controller causes a further alarm to be activated whereby the operator can be alerted to the fact that a second threshold has been reached.

4) A speed control device as claimed in claim 1, wherein, in the event that despite the operation of the alarm, a second threshold is reached, then the vehicle controller causes a further alarm to be activated whereby the operator can be alerted to the fact that a second threshold has been reached and, in the event that the operator take no corrective action, the motor controller will take appropriate action to alter the speed of the motor.

5) A speed control device as claimed in claim 1, wherein the speed data of the vehicle speed is determined with reference to a satellite-positioning signal.

6) A speed control device as claimed in claim 1, wherein there is a secondary speed determination system, operable to provide speed data in addition to the primary speed data or speed data in the event of non-reception of a primary signal data.

7) A speed control device as claimed in claim 1, wherein the motor controller takes instructions from the vehicle controller and is operable to:
i) allow normal operation of the engine;
ii) prevent operation of the motor;
iii) control the operation of the motor within certain limits.

8) A speed control device as claimed in claim 1, wherein the motor is selected from one of an electric motor, a spark ignition internal combustion motor; a compression ignition internal combustion motor; a gas turbine motor; a steam driven motor; a compressed air motor.

9) A speed control device as claimed in claim 1, wherein the vehicle is one of a road vehicle, an off-road vehicle, a watercraft or a self-propelled snow vehicle.

10) A speed control device as claimed in claim 1, wherein the interface operable to receive data relating to a specific operator comprises one of: a card reader device operable to read optically or magnetically encoded data stored upon a card; low-power wireless technology, a DVD player, operable to read data stored upon a DVD; a data entry pad, operable to receive manually input data, and: a USB connector operable to read data stored upon a USB stick or other memory device with a USB connector.

11) A speed control device as claimed in claim 1, wherein the third party is one of a parent or spouse of an operator; a traffic control authority, government authority, a transport firm, or a general business.

12) A speed control device as claimed in claim 1, wherein the vehicle control unit is equipped with an electronic memory operable to record data relating to previous journeys, and/or previous operators and/or navigational data relating to speed limits.

13) A speed control device as claimed in claim 1, wherein each component of the controller device has a tamper evident seal.

14) A speed control device or system for third party use as claimed in claim 1 further comprising a computer and an interface whereby to encode/download data to one or more of an optically or magnetically encoded data card; a DVD disc; a console operable to have data entered thereon, a USB connector operable to transfer data to a USB stick or other memory device with a USB connector.

15) A speed control device or system for a vehicle whereby a third party can impose supervisory control upon a specific vehicle and vehicle operator combination wherein the vehicle operator can not have control over the third party controlling, substantially as hereinbefore described with reference to the accompanying drawings.
